(19) United States
(12) Patent Application Publication
(10) Pub. No.: US 2007/0250378 A1
(43) Pub. Date: Oct. 25, 2007

(54) Systems and methods for conducting production competitions

(76) Inventors: John M. Hughes, Hebron, CT (US); Michael Lydon, Hebron, CT (US); David Messinger, West Hartford, CT (US); MaryBeth Luce, Frisco, CO (US); Robert Hughes, Marlborough, CT (US); Javier Fernandez-Ivern, Rocky Hill, CT (US)

Correspondence Address: GOODWIN PROCTER LLP;PATENT ADMINISTRATOR, EXCHANGE PLACE, BOSTON, MA, 02109-2881, US

(21) Appl. No.: 11/410,513

(22) Filed: Apr. 24, 2006

(51) Int. Cl. G06F 11/34

(52) U.S. Cl. 705/11

(57) ABSTRACT

This invention relates to methods and a system for compensating contestants for participating in development competitions. In one embodiment, a method for compensating contestants for participating in development competitions includes conducting development competitions in which contestants each submit a development, and for each competition evaluating contestants' submissions; based on the evaluation, assigning a score to contestants' submissions, identifying a number of submissions having a score above a threshold value, designating the contestant who submitted a submission having a score above the threshold value that is the highest score to be the winner of that competition, and awarding performance points to contestants who submitted the identified submissions. The method further includes periodically awarding prizes to the contestants who receive the greatest number of performance points during the period.

### TECHNICAL FIELD

This invention relates to computer-based methods and systems for conducting production competitions, and, more particularly, to methods and systems for motivating participants to participate in a series of production competitions.

### BACKGROUND INFORMATION

In the United States and elsewhere, computers have become part of people's everyday lives, both in the workplace and in personal endeavors. This is because a general-purpose computer can be programmed to run a variety of software programs each providing different processing and networking functions. Computers are also used to enable the production of work product.

For example, computer programmers produce computer code. Some companies hire large numbers of computer programmers to produce code on the company's behalf.

One approach companies take is to hire large numbers of programmers and develop software “in house.” While this affords significant control over the programming staff, finding, hiring, and maintaining such a staff can be cost prohibitive. Furthermore, as individual programmers leave the company, much of the technical and industrial knowledge is also lost. Alternatively, many companies “outsource” their programming through consulting firms, or contract employees. This approach relieves the company of the burdens of managing individual employees, however the quality and consistency of the work may be suspect, and the challenges of integrating work from numerous outside vendors can be significant.

A similar approach is often used for the production of other work product, such as logos, web pages, product designs, user interfaces, manuals, documentation, papers, and more. For example, companies often hire professional branding and design firms to create designs for use as potential corporate logos. Like many designs, corporate logos have an aesthetic quality, and so different people have an affinity for different appearances and styles. It can be challenging, therefore, to design a logo that is appreciated by many different people. At the same time, however, a logo also is an important part of the public presentation of a company. It therefore may be very important to a company to quickly and inexpensively select a logo, for example, that will be appreciated by many different people within a company, as well as by the company's customers and business partners. And again, companies are faced with the questions of whether to hire employees to produce the work product or to outsource, how to motivate the workers producing the work product, and how to reward workers for their efforts.

### SUMMARY OF THE INVENTION

Organizations need to obtain high-quality work product, while being assured that the assets are produced using appropriate quality measures and adhere to desired standards, in an affordable manner. In general, the invention relates to techniques for motivating and rewarding individuals and/or teams to participate in a series of contests that each produce work product, resulting in a repeatable, structured model that transforms a production process from an ad-hoc, custom exercise into a streamlined, predictable operation.

Generally speaking, this goal can be achieved, in one embodiment, by conducting a predictable ongoing series of contests in which contestants are motivated to compete to produce their best work product. The best work product in a particular contest, as determined by fair evaluation, is designated the winner(s). The skill and/or reliability of contestants may be rated. In addition, incentives may be provided to encourage ongoing participation in a manner that is productive both for the contestant and the production process. Conducting the contests in an ongoing manner allows contestants to schedule their time to include participation, develop their production skills, and also allows for a continued production workflow, as new work comes in and is produced by a contest model.

For example, in one exemplary implementation related to software production, software design functions are separated from software development functions and rigorous review processes are provided in a competition model whereby a number of distributed, unrelated, and motivated developers submit multiple software designs or programs, from which the eventual software design or program is selected. The contestants are further motivated contestants to participate in multiple contests through the provision of incentives that encourage continued participation and skill development.

The techniques described may be applied to the production of any suitable work product. For example, creative design projects, including projects such as web page design, branding designs, logos, user interface design, banner and other advertising design, stationary design, music and song composition, documentation and paper writing, and so on all have characteristics that are similar to software in the sense that they are work product that may be produced by an individual or team. In addition, they may contribute to a customer's impression of an organization and/or its products, and so are work products that are desired by organizations.

For example, organizations need a way to quickly and efficiently produce designs that will be received positively by their target audience. It can be difficult to efficiently generate a number of different ideas and then identify the one that will be best received by the target audience. One technique that can help address these concerns is to use a design competition, in which a number of design developers submit candidate designs for selection. Having a number of different people work on the design production helps generate many different approaches.

In such a contest, a winner is typically awarded with a prize. It may be very helpful in this context, however, to encourage participation by offering incentives to contestants who do not win. In order to encourage participation in such contests, it is possible to award prizes to the contestants based on the number and quality of their submissions over some period of time. In one embodiment, points are awarded to participants who are contestants in multiple competitions based on the number of qualified participants and/or submissions in the contest (e.g., those that produce a work product of sufficient quality, by a specified date, or both) and the quality of a contestant's individual submission. For example, in each contest, submissions may be initially screened to identify those that meet minimum quality standards, and individually scored based on specifications and guidelines. A submission receiving the highest score in a contest may be determined to be the winner of the contest. Points also may be awarded to the participants based on the number of submissions passing the initial screening process and their scores.

These performance points and awards may be separate from rating or ranking the skills and/or reliability of a contestant. While a rating may indicate how a contestant's skills compares to others, performance points and awards may reward consistent, high-quality participation. Such participation is necessary for contestants to improve their skills, and also to maintain a high-quality pool of contestants.

In general, in one aspect, production competitions are conducted in which contestants each submit work product. For each competition, the submissions are evaluated (against one or more criteria, for example) and scored based on the evaluation. Submissions meeting a certain threshold are identified, and the contestant(s) who submitted the work product meeting the threshold and having the highest score(s) is/are designated as the winner of that competition. Performance points are awarded to the contestants who submitted developments that met the threshold, and prizes are periodically (e.g., quarterly, annually, or both) awarded to contestants who receive the greatest number of performance points during the period. In some embodiments, a prize can also be awarded to the one or more contestant(s) who submitted the work product(s) having the highest score(s) in a particular competition. In some embodiments, an ongoing rating is determined for each of the contestants, which is indicative of a level of skill and/or reliability, in response to the score and a previous (or initial) rating.

Various embodiments can include one or more of the following features. The evaluation can be performed by a number of evaluators. The evaluator(s) may not know the identity of the contestant who submitted the work product being evaluated. Prior to evaluation, the submissions may be reviewed to determine whether they meet minimum submission requirements. In cases where two submissions have an evaluation score above the threshold, the two contestants who submitted the two submissions having the highest scores in the competition to be the winner of the competition and the second place finisher of the competition. In some cases, a prize can also be awarded to the second place finisher. The points may be awarded in response to the number of submissions received, and/or in some cases, the number of submissions that score above the threshold. In some cases, there may be deductions for certain deficiencies in the submissions.

In another aspect of the invention, a method for generating an intellectual asset includes portioning production of the asset into production tasks for each of one or more work product elements, each of which can be produced by a submitter participating in a production competition for the production of the work product elements. The production competition includes describing the requested work product (and in some cases the criteria used to evaluate the submissions), receiving contestants work product submissions, evaluating contestants' work product submissions, assigning a score to contestants' work product submissions in response to the evaluation, identifying a number of work product submissions having a score over a threshold value, and designating the contestant who submitted a submission having a score above the threshold value that is a highest score to be a winner of the competition. The method also includes awarding performance points to contestants who submitted the identified work product submissions and periodically awarding prizes to a plurality of contestants receiving the greatest number of performance points during the period.

In another aspect, the invention relates to systems for implementing the methods just described. For example, a system for conducting production competitions includes a communications server for communicating requirements for a production to contestants and, in response to the communicated requirements, receiving from a subset of the contestants a candidate submission; a testing server for evaluating the received submissions; and a scoring server for (i) scoring the submissions based on the evaluation results; (ii) identifying submissions with scores above a threshold; and (iii) allocating performance points to those contestants that submitted the identified work product.

In one embodiment of this aspect of the invention, the system also includes a data storage module for storing criteria on which the evaluations are based. The data storage module may also store a rating, volatility, and a number of previous competitions for each participant. The scoring server can also, in some instances, allocate performance points based on the number of submissions with scores above the threshold.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a distributed software development system having a server according to the invention.

FIG. 2 is a block diagram of one embodiment of a software development domain according to an embodiment of the invention.

FIG. 3 is a flow chart depicting steps performed in developing a software program according to an embodiment of the invention.

FIG. 4 is a flow chart depicting an overview of the operation of an embodiment of the invention.

FIG. 5 is a flow chart depicting steps performed in producing a design according to an embodiment of the invention.

FIG. 6 is a flow chart depicting steps performed in producing a design according to an embodiment of the invention.

FIG. 7 is a flow chart depicting steps performed in awarding participation points and prizes according to an embodiment of the invention.

FIG. 8 is a block diagram of an embodiment of a server such as that of FIG. 1 to facilitate the development and/or testing of software programs.

### DETAILED DESCRIPTION

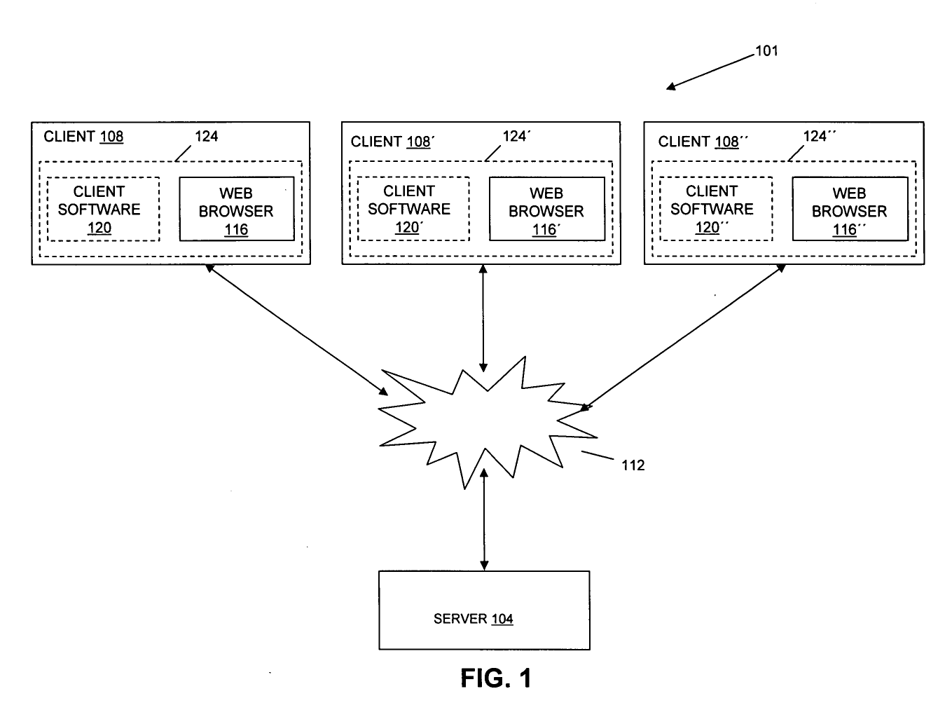

Referring to FIG. 1, in one embodiment, a distributed work product production system 101 includes at least one server 104, and at least one client 108, 108′, 108″, generally 108. As shown, production system includes three clients 108, 108′, 108″, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 could also be implemented on such hardware as a smart or dumb terminal, network computer, wireless device, wireless telephone, information appliance, workstation, minicomputer, mainframe computer, or other computing device that is operated as a general purpose computer or a special purpose hardware device used solely for serving as a client 108 in the distributed software development system.

Generally, in some embodiments, clients 108 can be operated and used by participants to participate in various production activities. Some examples of production activities include, but are not limited to software development projects, graphical design contests, webpage design contents, document authoring, document design, logo design contest, music and song composition, authoring of articles, architecture design projects, landscape designs, database designs, courseware, software design projects, supporting software programs, assembling software applications, testing software programs, participating in programming contests, as well as others. The techniques may be applied to any work product that may be produced by an individual or team, alone or in conjunction with a machine (preferably a computer) by way of a contest. Clients 108 can also be operated by entities who have requested that the designers and developers develop the assets being designed and/or developed by the designers and developers (e.g., customers). The customers may use the clients 108 to review, for example, software developed by software developers, logos designed by graphic artists, user interface designers, post specifications for the development of software programs, test software modules, view information about the contestants, as well as other activities described herein. The clients 108 may also be operated by a facilitator, acting as an intermediary between customers for the work product and the contestants.

In various embodiments, the client computer 108 includes a web browser 116, client software 120, or both. The web browser 116 allows the client 108 to request a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered the Mozilla Foundation.

In some embodiments, the client 108 also includes client software 120. The client software 120 provides functionality to the client 108 that allows a contestant to participate in, supervise, facilitate, or observe production activities described above. The client software 120 may be implemented in various forms, for example, it may be in the form of a Java applet that is downloaded to the client 108 and runs in conjunction with the web browser 116, or the client software 120 may be in the form of a standalone application, implemented in a multi-platform language such as Java or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface 124; for example, the client software can be implemented as a “plug-in” to the web browser 116.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 112 can carry TCP/IP protocol communications, and HTTP/HTTPS requests made by the web browser 116 and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired Ethernet-based intranet, a local or wide-area network (LAN or WAN), and/or the global communications network known as the Internet, which may accommodate many different communications media and protocols.

The servers 104 interact with clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 104 may be or may be part of a logical group of one or more servers such as a server farm or server network. As another example, there could be multiple servers 104 that may be associated or connected with each other, or multiple servers could operate independently, but with shared data. In a further embodiment and as is typical in large-scale systems, application software could be implemented in components, with different components running on different server computers, on the same server, or some combination.

In some embodiments, the server 104 also can include a contest server, such as described in U.S. Pat. Nos. 6,569,012 and 6,761,631, entitled “Systems and Methods for Coding Competitions” and “Apparatus and System for Facilitating Online Coding Competitions” respectively, both by Lydon et al, and incorporated by reference in their entirety herein.

In one embodiment, the server 104 and clients 108 may or may not be associated with the entity requesting the production of the work product.

In one embodiment, the work product being produced is an aesthetic design. Generally, an aesthetic design is a representation of a decorative, artistic and/or technical work that is created by the designer. For example, the design can be a graphic design, such as a logo, a graphic, or an illustration. The design can be a purposeful or inventive arrangement of parts or details. For example, the design can be the layout and graphics for a web page, web site, graphical user interface, and the like. The design can be a basic scheme or pattern that affects and controls function or development. For example, the design can be a prototype of a web page or pages, a software program or an application. As another example, the design can be a product (including without limitation any type of product, e.g., consumer product, industrial product, office product, vehicle, etc.) design or prototype. The design also can be a general or detailed plan for construction or manufacture of an object or a building (e.g., an architectural design). For example, the design can be a product design. The design can be the design for a computer program, as described in co-pending U.S. patent application Ser. No. 11/035,783, filed Jan. 14, 2005.

In one embodiment, the design is a logo that an individual, company, or other organization intends to use on its web site, business cards, signage, stationary, and/or marketing collateral and the like. In another embodiment, the design is a web page template, including colors, graphics, and text layout that will appear on various pages within a particular web site.

In one embodiment, the work product is a requirements specification for a software program, including the requirements that the program must meet and can include any sort of instructions for a machine, including, for example, without limitation, a component, a class, a library, an application, an applet, a script, a logic table, a data block, or any combination or collection of one or more of any one or more of these.

In instances where the work product describes (or is) a software program, the software program can be a software component. Generally, a software component is a functional software module that may be a reusable building block of an application. A component can have any function or functionality. Just as a few examples, software components may include, but are not limited to, such components as graphical user interface tools, a small interest calculator, an interface to a database manager, calculations for actuarial tables, a DNA search function, an interface to a manufacturing numerical control machine for the purpose of machining manufactured parts, a public/private key encryption algorithm, and functions for login and communication with a host application (e.g., insurance adjustment and point of sale (POS) product tracking). In some embodiments, components communicate with each other for needed services (e.g., over the communications network 112). A specific example of a component is a JavaBean, which is a component written in the Java programming language. A component can also be written in any other language, including without limitation Visual Basic, C++, Java, and C^{#}.

In one embodiment, the work product is an application that, in some cases, may be comprised of other work product such as software components, web page designs, logos, and text. In one embodiment, the software application is comprised of work product previously produced using the methods described herein. In some embodiments, the application comprises entirely new work product. In some embodiments, the application comprises a combination of new work product and previously produced work product.

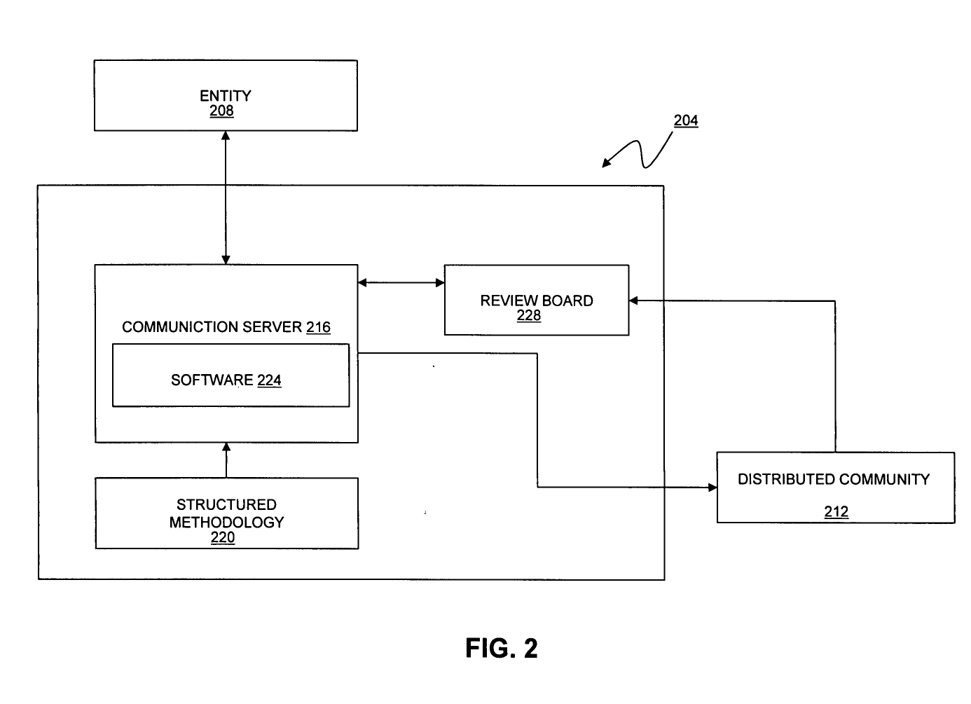

Referring to FIG. 2, a production domain 204 can be used to provide an entity 208 with high-quality work product. One or more contestants can be identified and/or selected by various methods from a distributed community 212, and subsequently used to produce the desired work product(s). For example, the members of the community can be employees of, consultants to, or members of an organization, enterprise, or a community fostering collaborative production, and in some cases the members of the community may have no other formal or informal relationship to each other. In some embodiments, one or more of the members of the community can act as a product manager who is responsible for organizing and coordinating the efforts of other members of the community to produce the work product. The product manager may also specify items such as, without limitation, the cost of the project, the project schedule, and the project risks. In one embodiment, the product manager creates a project plan for producing the work product, which may include, without limitation, an estimated project cost and schedule, and a requirements document describing, for example, the scope and risks of the project and the evaluation criteria against which submissions are to be evaluated, etc.

In some embodiments, the members of the community may include architects, graphic artists, designers, programmers, quality assurance engineers, or others with domain experience applicable to the work product, as well as other software development roles as described in co-pending U.S. patent application Ser. No. 10/408,402, entitled “Method and Systems for Software Development” by Hughes, and incorporated by reference in its entirety herein.

In one embodiment, the production domain 204 includes a communication server 216, one or more structured methodologies 220, production software 224, and a review board 228. The communication server provides a conduit through which the external entity 208, the members of the community 212, and the review board 228 can interact, for example, to provide work product to elicit and offer feedback, review submitted work product, and potentially rate submitted work product, either in design or functional form. In some embodiments, the communication server is or operates as part of the server 104 as described above, whereas in other cases the communication server may be a separate server, which may be operated by and/or outsourced to an application service provider (ASP), internet service provider (ISP), or other third-party.

In one embodiment in which the contest relates to software development, the structured methodology 220 provides a framework for the development of software programs. The methodology 220 specifies a common vocabulary, a fixed set of deliverables, development phases or steps, inputs and outputs for one or more of the steps, as well as other aspects of the development process. For example, the methodology 220 bifurcates the development process into an architecture and design phase and a development and testing phase. Furthermore, in this particular non-limiting example, the outputs of the architecture and design phase, such as class diagrams, test cases, technical specifications, and other design documents, are submitted, reviewed, and finalized prior to initiating any development work. Once a set of design documents are selected and approved, the design documents are used as input into the development phase. During the development and testing phase, the developer(s) create source code, scripts, documentation, and other deliverables based on the design documents. By assuring the high-quality of the design documents prior to beginning development, the developers are afforded a complete and accurate representation of what it is they are being asked to develop. Furthermore, by using a structured methodology, the participants, (e.g., developers 212, the entity 208) can communicate effectively, and the outputs of each process step are known and can be verified. By providing a common definition, and a known set of inputs, such as use cases, and a known set of outputs such as expected results, and facilitating community-based development, the developers can interact with each other effectively and efficiently, thus reducing the cost and time necessary to produce quality software.

The software 224 provides an operational mechanism for implementing the methodology 220, and a production environment in which the developers can do one or more of develop, test, submit, and verify their work product. In some embodiments, as shown, components of the software 224 may reside on the server 104, whereas some components may be included in client software residing on a client, e.g., as described above. The software 224 optionally can include one or more modules such as a development library, from which developers can access previously developed components, work product and documentation templates; a documentation feature that provides information about terms, syntax, and functions; a compiler that also allows a developer to identify and correct programming errors; and even version control and code management functions.

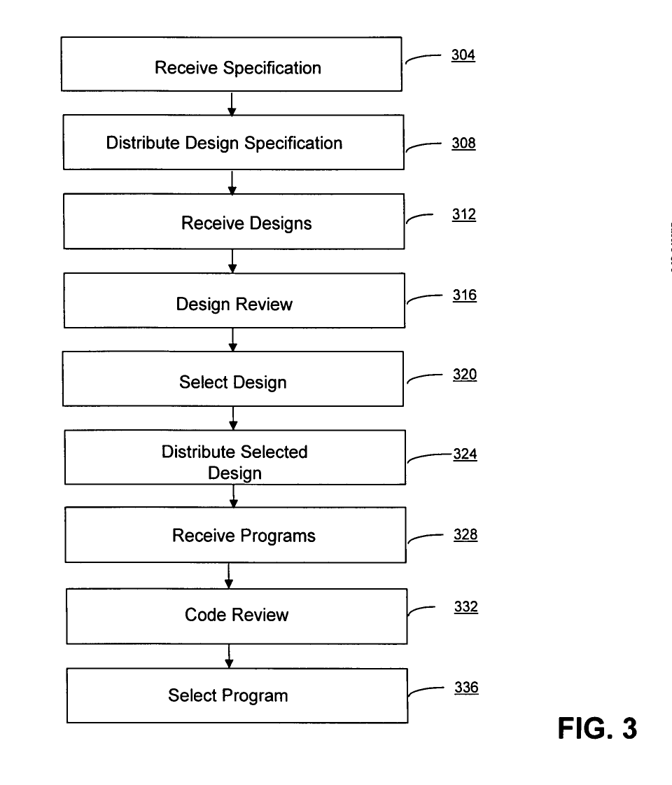

FIG. 3 provides a summary illustration of one embodiment of a method for developing software, as one example, using the production domain 204 described above. The communication server 216 receives a specification (STEP 304) describing the desired functions of a software program, which is then distributed to the distributed community of programmers 212 (STEP 308). One or more of the members of the community 212 creates a design detailing the technical aspects of the program based on the functionality described in the specification, and once completed, the design(s) are received at the server 104 (STEP 312). The submitted design(s) are then subject to a design review process (STEP 316) whereby the design(s) are compared to the specification, and evaluated on their implementation of the specified functionality and compliance with the structured methodology 220. A design that is the “best” of the submissions may be selected in response to the evaluations (STEP 320), and if there is at least one submission of sufficient quality, the selected design may be made available to the members of the community 212 (STEP 324). Each of a number of programmers (or, in some cases, each of teams of programmers) submits a software program that they believe conforms to the design and the requirements of the structured methodology 220. The software programs are received at the server 104 (STEP 328) and the programs are subjected to a software review process (STEP 332) to determine which submitted program(s) best conform to the distributed design and the structured development methodology 220. Once reviewed, one (or in some cases more than one, or none if none are of sufficient quality) program is identified as a “winning” submission (STEP 336).

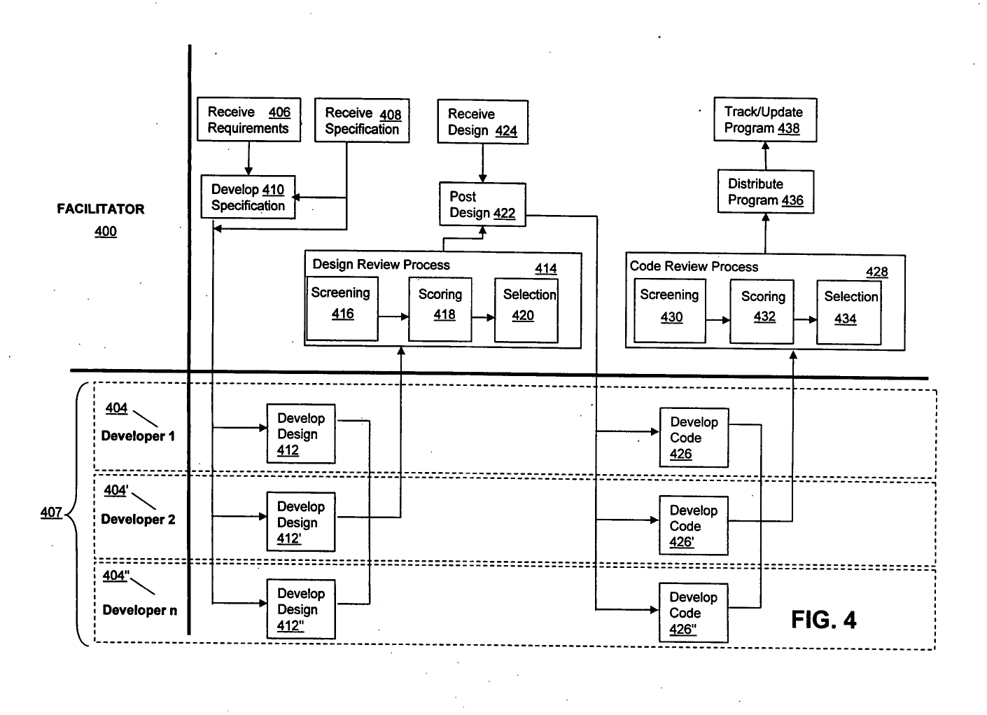

FIG. 4 provides one possible implementation of the general method described above. In some such embodiments, the development process is monitored and managed by a facilitator 400. The facilitator 400 can be any individual, group, or entity capable of performing the functions described here. In some cases, the facilitator 400 can be selected from the members of the community 212 based on, for example, achieving exemplary scores on previously submitted work product, or achieving a high ranking in a skill or production contest. In other cases, the facilitator 400 can be appointed or supplied by the entity (e.g., entity 208) requesting the development of the software program, for example, and thus oversee the production process for further assurance that the end product will comport with the specifications.

Initially, the facilitator 400 receives input from an entity (not shown) wishing to have an asset developed on their behalf. In the case of a software program, the entity can be a company looking to have one or more computer programs designed and/or developed for internal use, or as portions of larger applications that they intend to sell commercially. In some cases, the entity provides a detailed specification, and in other cases only a list of functional requirements may be provided. The facilitator receives either the requirements (STEP 406), the specification (STEP 408), or in some cases both from the external entity. If, however, no specification is provided, or of the specification needs revisions to conform to the methodology, the facilitator can develop a specification in accordance with the requirements (STEP 410). In some cases, one or more members of the development community 407 (e.g., production community 212 in FIG. 2) may be asked to develop the specification, and in some cases multiple specifications may be submitted, with one of the submissions selected as the final specification to be used for guiding the design and development efforts.

In one embodiment, the specification defines the business plan and a stable hardware and/or software platform, or other architectural, environmental, or artistic constraints. For example, in the software development context, the specification can define the network devices, servers, and general infrastructure to support the development and production of the project and product. The specification can also identify a language or tools that the component must be programmed in or with, a functional overview of the software component, boundary conditions, efficiency requirements, computer platform/environment requirements, interface requirements, performance criteria, test-case requirements, and/or documentation requirements of the component. In some embodiments, the specification can include an amount of money that will be paid to the designer who submits the best design and/or program that complies with the specification.

In some cases, the specification is assigned a difficulty level, or some similar indication of how difficult the facilitator, entity, or other evaluator of the specification, believes it will be to produce a comprehensive design according to the specification. The difficulty level may, in some cases, also be based on the effort believed to be necessary to complete the task, and the time allotted to complete the task. The difficulty level may be expressed in any suitable manner, for example as a numerical measure (e.g., a scale of 1 to 10), a letter grade, or a descriptive such as easy, medium, or hard. For example, a specification for the design of a complex gene-sequencing algorithm may have a difficulty level of 9 on a scale of 1 to 10, whereas a simple component that performs a search for specific text in a file may be assigned a difficulty level of 2. If there are additional practical constraints, for example if the search component is needed in two days, the difficulty level optionally may be increased due to the tight time constraints. In some embodiments, an award to the designer (e.g., money, skill rating, etc.) that submits the selected design may be produced or adjusted based in part on the difficulty level associated with the specification.

Once the specification is received (or developed), the facilitator 400 (or in some cases a project manager) reviews the specification to determine if it meets the requirements for a complete specification according to the methodology 220. The methodology can include best-practice activities, templates, guidelines, and standards that assist software architects, programmers, and developers in producing quality code in a consistent and efficient manner. The use of such a methodology reduces the need to rethink and recreate programming documentation and constructs, thus reducing project duration, cost, and increasing quality and component reusability.

Once complete, the specification is distributed via the communications server 212 to one or more developers 404, 404′, 404″ (generally, 404), who may be members, for example, of a distributed community of programmers such as the community 212 shown in FIG. 2. In one non-limiting example, the developers 404 are unrelated to each other. For example, the developers may have no common employer, may be geographically dispersed throughout the world, and in some cases have not previously interacted with each other. However, as members of the community 212, the developers 404 may have participated in one or more competitions, and/or have had previously submitted software artifacts subject to reviews. This approach allows an entity 208 to gain access to a large pool of qualified software developers.

The communication can occur over a communications network such as the network 112 (FIG. 1), such as via an email, instant message, text message, a posting on a web page accessible by the web browser 116, through a news group, facsimile, or any other suitable communication. In some embodiments, the communication of the specification can be accompanied by an indication of a prize, payment, or other recognition that is available to the designer(s) that submit selected software design(s). In some cases, the amount and/or type of payment may change over time, or as the number of participants increases or decreases, or both. In some cases multiple designers may be rewarded with different amounts, for example a larger reward for the best design, and a smaller reward for second place. The number of designers receiving an award can be based on, for example, the number of designers participating in the design project, or other similar attributes.

The recipients of the specification can be selected by various means. In some embodiments, members of the community may have expressed interest in participating in a development project, whereas in some cases the individuals are selected based on previous performances in coding competitions, prior development projects, or other methods of measuring the programming skill of a software developer. For example, the members of the distributed community of programmers may be programmers who have previously participated in an on-line programming competition. In such a case, the programming skills of the participants may have been rated according to their performance, either individually, as a team, or in relation to other programmers, and the ratings may be used to determine which programmers are eligible to receive notification of a new specification or respond to a notification.

In one embodiment, the facilitator 400 moderates a collaborative forum among the various participants (the external entity 208, the developers 404, etc.) to determine, discuss, or collaborate on design features. The collaborative forum can consist of developers, customers, prospective customers, or others interested in the development of certain software. In one embodiment, the collaboration forum is an online forum where participants can post ideas, questions, suggestions, or other information. In some embodiments, only a subset of the forum members can post suggestions to the forum.

Upon receipt of the specification, one or more developers 404 each develop software designs (STEPS 412, 412′ and 412″) in accordance with the specification. The development of the software design can be done using any suitable development system, for example, the software development software 224 provided via the communication server 216, a development environment provided by the developer 404, or some combination thereof. Once a developer 404 is satisfied that her design meets the specified requirements, and follows the structured development methodology 220, she submits her design e.g., via the communications server 216, facsimile, email, mail, or other similar methods.

To determine which design will be used as the design for the software program, a design review process (STEP 414) is used. This design review can take place in any number of ways. In some cases, the facilitator 400 can delegate the review process to one or more members of the distributed community of programmers, or an appointee of the entity. The design review process, in some embodiments, includes one or more developers 404 acting as a design review board to review design submissions from software designers. The design review board preferably has a small number of (e.g., less than ten) members, for example, three members, but can be any number. Generally, the review board is formed for only one or a small number of related projects, for example three projects. Review boards, in some embodiments, could be formed for an extended time, but changes in staffing also can help maintain quality.

Preferably, one member of the design review board members is selected as the primary review board member by the facilitator 400 and/or the project manager, the members of the review board, and/or the external entity requesting the software program. In some cases, the facilitator 400 or a representative of the facilitator 400 acts as the primary review board member. The primary review board member is responsible for coordination and management of the activities of the board.

In one embodiment, submissions for software designs are judged by the design review board. In some embodiments, the primary review board member screens the design submissions before they are reviewed by the other members of the design review board, to allow the rest of the review board to judge only the best of the submissions. In some embodiments, the screening process includes scoring the submissions based on the degree to which they meet formal requirements outlined in the specification (e.g., format and elements submitted). In some embodiments, scores are documented using a scorecard, which can be a document, spreadsheet, online form, database, or other electronic document. The design review board may also, in some cases, verify the anonymity of the developers 404 such that their identities cannot be discerned from their submissions.

A screening review can determine whether the required elements of the design are included (e.g., class, use-case, and sequence diagrams, component specification, required algorithms, class stubs, and functional tests). The screening review can also determine that these elements appear complete. With regard to the class diagram, for example, and in particular the class definition, the screening review can determine any or all of that: (1) the class definition provides a descriptive overview of the class usage, (2) sub-packages have been created to separate functionality, (3) class scope matches class usage, (4) there is proper and effective use of programming techniques such as inheritance and abstraction, (5) interfaces are used properly, (6) suitable constructors are defined for the component, and that (7) class modifiers such as final and static, are appropriately used. The screening review can also determine, for example, with regard to variable definitions, that: (1) variable scope is correctly defined, (2) type assignments are defined appropriately for balance between efficiency and flexibility, and (3) that all variables are defined with an initial value. Further, with regard to method definitions, for example, the screening review can determine that: (1) scope is correctly defined, (2) exceptions are handled and used appropriately, (3) modifiers are properly used, (4) return types are used, (5) method arguments are properly defined, and (6) that the application programming interface (API) as stated in the requirements specification is available.

The screening review can also, for example, verify that use-case diagrams exist for all public methods in the design, and that sequence diagrams exist for each use case. The screening review can also, for example, with regard to test cases, verify that functional test cases are provided for each sequence diagram, and that they appear to be appropriate for those diagrams. The designs can take a number of forms, depending on the program specified. Typically, the specifications will include the requirements for the design. In one embodiment, the design requirements include class diagrams, which can be developed in the Unified Modeling Language (UML), for example using the Poseideon Computer Aided Software Engineering (CASE) tool, available from Gentleware AG of Hamburg, Germany. The design requirements also include use-case diagrams and sequence diagrams. The design requirements also include a written component design specification describing the design, a list of required algorithms, and class stubs for the classes in the design. The design requirements also include functional tests that can be used to test the program. In one such embodiment, the functional tests are tests compatible with the JUnit testing infrastructure. JUnit is open source software for testing Java software, which is available from www.sourceforge.net.

In one embodiment, the primary review board member informs the design review board that one or more submissions have passed the initial screening process (STEP 416), and the design review board then evaluates the design submissions in greater detail. In some embodiments, the design review board reviews the submissions based on requirements documented in the specification. In some embodiments, the design review board scores the submissions (STEP 418). In some embodiments, the scores are documented using a scorecard, which can be any form, including a document, spreadsheet, online form, database, or other electronic document.

In some embodiments, the scores and reviews from the primary review board member and the other members of the design review board are aggregated into a final review and score. In some embodiments, the aggregation can comprise compiling information contained in one or more documents. Such aggregation can be performed by the primary review board member, the other members of the design review board, or in one exemplary embodiment, the aggregation is performed using a computer-based system which resides on the server 104 (FIG. 1). In some embodiments, the facilitator 400 or the primary review board member resolves discrepancies or disagreements among the members of the design review board.

In one embodiment, the design with the highest combined score is selected as the winning design that will be used for implementation (STEP 420). A prize, payment and/or recognition is given to the designer. In one embodiment, a portion of the payment to the designer is withheld until the end of the development review. For example, the designer may receive 75% of the payment at the end of the design review, and 25% is paid after the code review. There can also be prizes, payments, and/or recognition for the other submitted designs. For example, the designers that submit the second and third best designs may also receive payment, which in some cases may be less than that of the winning designer. Payments may also be made for creative use of technology, submitting a unique test case, or other such submissions. In some embodiments, the software developers can contest the score assigned to their design, program, or other submissions.

In some cases, the posted design is assigned a difficulty level, or some similar indication of how difficult the external entity, facilitator 400 or some evaluator of the design believes it will be to produce a software program or component that meets the requirements of the selected design. Like the difficulty levels assigned to the specification, the difficulty level assigned to a design may, in some cases, also factor in the effort believed to be necessary to complete the task, and the time allotted to complete the task. In some embodiments, the recognition awarded to the designer (e.g., money, skill rating, etc.) that submits the selected design may be adjusted based in part on the difficulty level associated with the specification.

In some embodiments, in addition to reviewing the submissions, the design review board can identify useful modifications to the design that should be included into the design prior to entering the development phase. The primary review board member documents the additional requirements, and communicates this information to the designer 404 who submitted the design. In one embodiment, the primary review board member aggregates the comments from the review board. The developer 404 can update the design and resubmit it for review by the design review board. This process can repeat until the primary review board member believes the design has met all the necessary requirements.

Once the design review board validates that a design has sufficiently addressed the requirements of the specification, the primary review board member notifies the facilitator 400, product manager, or external entity that such a design has passed the design review process. The design can then be posted and/or distributed (STEP 422) to the community of developers 407 to solicit submissions for software programs that conform to the design. For example, the facilitator 400 can make the design available on a web site and/or a mailing list for implementation, and request components according to the design.

In one alternative embodiment, and as an example of the flexibility of the system, the entity develops the software design and provides the design to the facilitator 400 as input directly into the development process. The facilitator 400 receives the design (STEP 424) and optionally initiates a review process as described above to confirm that the design meets the standards of the structured development methodology 220. Using this approach, an entity wishing to maintain control of the design phase of the software development process (e.g., architecture, platform, coding standards, etc.) can utilize internal or other resources such as business and systems analysts to develop a design that complies with their standards, and then utilize a distributed community of developers 212 to develop the end product. Generally, this alternative maintains the design aspects of the software development process in-house, and “outsources” the manufacturing aspects of the development process such that the development domain 204 can use repeatable, structured development methods and the community of developers 212 to develop the software programs. Similarly, the entity 208 may only require the services of the development domain 204 to develop a software design, and subsequently use other resources such as in house programmers or off shore developers to develop the code.

The flexibility provided by maintaining multiple entry and exit points into and out of the development process allows external entities to decide, on a case by case or phase by phase basis whether to utilize the development domain 204 from start to finish, (i.e., specification through testing and support) or only use the domain 204 for specific phases of the process (i.e., development of code, development of a specification, development of a software design, testing, support, etc.).

In cases where the desired asset to be developed is a design (e.g., a logo, graphic design, etc.) the design with the highest score from the design review process is identified as the winning design and provided to the entity as a completed design. A number of designs also may be used as a starting point for another design contest, for iterative production.

If, as in some cases, the winning design is a design for a software component, the design can be used as input into a development contest. Referring still to FIG. 4, the selected and approved design is posted or provided to members of the members of the community 212. As above, with the specification, the design may be sent to the entire community or only selected members of the community. In versions where the design is sent to selected members, the selection process can be based on any or a combination of suitable criteria, for example, without limitation, past performances in programming competitions, the quality of previously submitted software programs, involvement in the development of the design, or by specific request of the facilitator 400, entity 208, the designer that submitted the winning design, other designers, or other members of the community 212. In some embodiments, the communication of the design can be accompanied by an indication of a prize, payment, or other recognition that is available to the developer that submits a selected software program, and/or runners up. In some cases, the amount and/or type of payment may change over time, or as the number of participants increases or decreases.

Each developer 404 develops software code (STEPS 426, 426′, and 426″) meeting the requirements of the selected design, and when completed, submits the code for example to the facilitator 400 or the server. As described above, the developers 404 may use a variety of coding techniques, languages, and development environments to develop the software, so long as the code meets, for example, the functional and architectural aspects dictated by the design and the quality and syntactical standards outlined by the structured development methodology 220. In some embodiments, the developers 404 may use the software development software 224 provided via the communication server 216 to assist with the development tasks. Because the development software 224 and development methodology 220 are both maintained within the development domain 204, many of the coding and quality control requirements of the methodology 220 can be built into the software 224, further assisting the developers 404 to develop quality code in an efficient manner.

To determine which software program will ultimately be selected as the program to be delivered to the entity 208, a code review process (STEP 428) is used, which can take place in any suitable manner. The code review process, in some embodiments, includes one or more developers 404 acting as a code review board to review submitted software programs from software developers. The code review board preferably has a small number of members (e.g., less than ten), for example, three members, but can be any number. Generally, the code review board is formed for only one or a small number of related projects, for example three projects, and then disbanded to allow the members to participate in additional design review boards, code review boards, or participate as designers and/or developers themselves. Review boards, in some embodiments, could be formed for an extended time, but changes in staffing also can help maintain quality.

Preferably, one member of the code review board members is selected as the primary code reviewer by the facilitator 404 and/or the project manager, the members of the review board, and/or the external entity requesting the software program. In some cases, the facilitator 400 or a representative of the facilitator 400 acts as the primary code board member. The primary code board member is responsible for coordination and management of the activities of the board.

In one embodiment, submissions of software programs are judged by the code review board. In some embodiments, the primary review board member screens the code submissions before they are reviewed by the other members of the code review board, to allow the rest of the code board to judge only the best of the submissions, for example, those that meet minimal requirements. In some embodiments, the screening process includes scoring the submissions based on the degree to which they meet formal requirements outlined in the selected design (e.g., format and elements submitted). In some embodiments, scores are documented using a scorecard, which can be a document, spreadsheet, online form, database, or other electronic document.

In one embodiment, for example, with regard to software code, the code reviewer scores the code based on the extent to which: (1) the submitted code addresses the functionality as detailed in component design documents; (2) the submitted code correctly uses all required technologies (e.g. language, required components, etc.) and packages; (3) the submitted code properly implements required algorithms; (4) the submitted code has correctly implemented (and not modified) the public application programming interface (API) as defined in the design, with no additional public classes, methods, or variables.

With regard to the source code, for example, the screening review can determine any or all of that: (1) all public methods are clearly commented; (2) required tags such as “@author,” “@param,” “@return,” “@throws,” and “@version” are included; (3) the copyright tag is populated; (4) the source code follows standard coding conventions for the Java language such as those published by Sun Microsystems; (5) a 4 space indentation is used in lieu of a tab indentation; and (6) all class, method and variable definitions found in the class diagram are accurately represented in the source code. The code review can also, for example, verify that unit test cases exist for all public methods in the design, and each unit test is properly identified by a testing program.

With regard to class definitions, for example, the reviewer can evaluate the code based on the extent to which classes are implemented as defined in design documents (including, for example, modifiers, types, and naming conventions), and whether defined classes are implemented. With regard to variable definitions and method definitions, for example, the reviewer can determine the extent to which all variables and methods are implemented as defined in the design documents (including, for example, modifiers, types, and naming conventions). With regard to relationships, for example, the reviewer can determine the extent to which the implementation properly maps class relationships.

The reviewer can further evaluate code based on a code inspection. For example, the reviewer can determine the extent to which the object types defined in the code are the best choices for the intended usage—for example whether a Vector type should have been used instead of an Array type. The reviewer can determine the extent to which there are any needless loops, or careless object instantiation or variable assignment.

The review can also inspect the test cases. With regard to test cases, for example, the reviewer can determine the extent to which (1) the unit test cases thoroughly test all methods and constructors; (2) the unit test cases properly make use of setup and teardown methods to configure the test environment; (3) files used in unit test cases exist in the designated directory; (4) unit test cases do not leave temporary files on the file system after testing is complete.

The reviewer can run tests on the code using test cases, for example test cases developed by the developer 404, other developers, the reviewers, the facilitator 400, the entity 208, as well as others. The reviewer can even further score the code by conducting accuracy, failure, and stress tests. Accuracy tests test the accuracy of the resulting output when provided valid input. Accuracy tests can also validate configuration data. Failure tests test for correct failure behavior when the component is provided with invalid input, such as bad data and incorrect usage. Stress tests test the component capacity for high-volume operation, but testing such characteristics as performance as throughput. The tests that fail are included in the evaluation of the component, for example as a score reduction. The reviewer can then assign an overall score to the component based on this evaluation.

In one embodiment, the primary review board member informs the code review board that one or more submissions have passed the initial screening step (STEP 430), and the code review board can then evaluate the program submissions in greater detail. In some embodiments, the code review board can review the submissions based on design requirements documented in the selected design. The code review board can then score the submissions (STEP 432) based on the results of the evaluations. In some embodiments, the scores are documented using a scorecard, which can be any suitable means, such as a document, spreadsheet, online form, database, or other electronic document.

In some embodiments, the scores and reviews from the primary code board member and the other members of the code review board are aggregated into a final review and score. In some embodiments, aggregation can comprise compiling information contained in one or more documents. Such aggregation can be performed by the facilitator 400, the primary code board member, the other members of the code review board or in one exemplary embodiment, the aggregation is performed using a computer-based system which resides on the server 104 (FIG. 1). In some embodiments, the facilitator 400 or the primary review board member resolves discrepancies or disagreements among the members of the code review board.

In one embodiment, the software program with the highest combined score is selected as the winning program (STEP 434) that will be delivered to the external entity 208 as a finished product (STEP 436). In some embodiments, a prize, payment and/or recognition is given to the software developer that submitted the winning program. There can also be prizes, payments, and/or recognition for the other submitted programs, as described in greater detail below. For example, the programmers that submit the second and third best programs may also receive payment, which in some cases may be less than that of the winning programmer. Payments may also be made for creative use of technology, submitting a unique test case, or other such submissions. In some embodiments, the software developers can contest the score assigned to their programs, test cases, or other submissions.

In some embodiments, in addition to reviewing the submissions, the code review board can identify useful modifications to the program that should be included into a selected software program prior to distribution. The primary code review board member documents the additional requirements, and communicates this information to the developer 404 who submitted the code. In one embodiment, the primary code review board member aggregates the comments from the review board. The developer 404 can update the program and resubmit it for review by the code review board. This process can repeat until the primary review board member believes the program has met all the necessary requirements and meets the standards specified in the structured development methodology 220.

In some embodiments, the software may be updated with enhancements, post-delivery bug fixes, additional functionality, or modified to operate in additional computing environments or platforms after it has been delivered to one or more entity 208. In such cases, the domain 204 provides for the tracking and updating (STEP 438) of previously distributed software products, as described in co-pending U.S. patent application Ser. No. 10/408,402, entitled “Method and Systems for Software Development” by Hughes, filed on Apr. 7, 2003, and incorporated by reference in its entirety herein.

For example, in one embodiment, an entity commissions the development of a software component, and upon completion of the component, version 1 of the component is distributed to the entity 208. Subsequently, a second entity 208 requests the development of a similar component that performs the same functionality, however to meet the specific request of the second entity, some modifications are made to the component. A modification is, for example, an improvement (e.g., efficiency increase, smaller memory requirements), deletion (e.g., of an unneeded step or feature), and an addition (e.g., of a complimentary feature or function) to the component. Another example of a modification is the integration of the component into another component (e.g., a larger component). In response to the request for the modified component, a new version of the component (version 1.1, for example) is developed and distributed to the second entity 208. In one embodiment, a message is sent to the first entity 208 stating that an updated version of the component is available. In further embodiments, the costs for developing the newer version of the component can be shared among the recipients of the original component (version 1) who wish to receive the new version, as well as the entity that initiated the development of the new version. Additionally, in some embodiments the entity 208 that requested the development of the new version is compensated for licenses/sales of copies of the second version of the component.

As mentioned above, in some embodiments, the developers 404 submit one or more test cases in addition to submitting the completed software program. The purpose of the test cases is to provide sample data and expected outputs against which the program can run, and the actual output of which can be compared to the expected outputs. By submitting multiple test cases, many different scenarios can be tested in isolation, therefore specific processing errors or omissions can be identified. For example, a program that calculates amortization tables for loans may require input data such as an interest rate, a principal amount, a payment horizon, and a payment frequency. Each data element may need to be checked such that null sets, zeros, negative numbers, decimals, special characters, etc. are all accounted for and the appropriate error checking and messages are invoked. In addition, the mathematical calculations should be verified and extreme input values such as long payment periods, daily payments, very large or very small principal amounts, and fractional interest rates should also be verified. In some versions, one test case can be developed to check each of these cases, however in other versions, it may be beneficial to provide individual test cases for each type of error. In certain embodiments, the multiple test cases can then be incorporated into a larger test program (e.g., a script, shell, or other high level program) and run concurrently or simultaneously.

In general, developers are encouraged to develop test cases as they are coding so that they can consider the bounding and error conditions as they code. It can be beneficial to use the test cases developed by one or more, or all, of the other submitters to test each of the submitted programs to cover as many error conditions as possible.

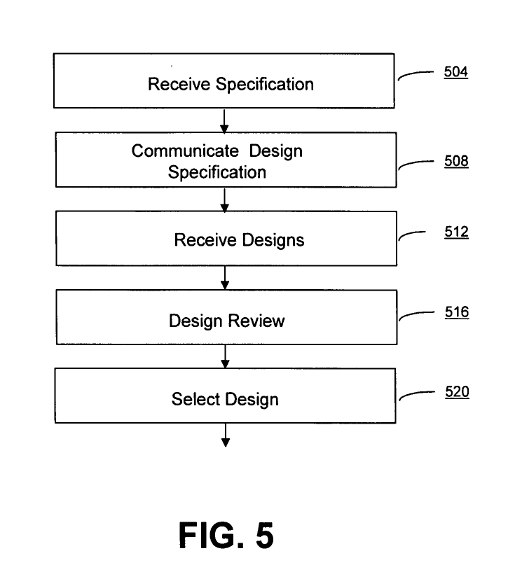

FIG. 5 provides a summary illustration of one embodiment of a method for developing a design, for example, using the domain described above. The communication server receives a specification (STEP 504) describing the desired design. The specification can include such information as the type of design, the size of the design, the size and color requirements, desired or undesired themes for the design, background information for creating the design, acceptable files types and formats for the submission, required documentation, and the like. The specification is then communicated to the distributed community of designers (STEP 508). The specification can be communicated by posting to a web site that is accessed by members of the distributed community of designers. The specification can be communicated via email, instant message (IM), or through any other suitable communication technique. The specification can also include any timing deadlines for response, and the prize to be paid for one or more selected (e.g., winning) design(s). For example, prizes can be awarded for first, second, and third place, and the prizes described in the specification.

One or more of the design developers in the community creates a design in response to the requirements described in the specification. Once completed, the design(s) are communicated to, and received at the server (STEP 512). The submitted design(s) are then subject to a design review process (STEP 516). In one embodiment, one or more reviewers (e.g., skilled, experienced and/or highly rated experts, focus groups, a customer, etc.) compare the design(s) to the specification, and evaluate the submissions on their implementation of the requirements (e.g., compliance with the methodology) and the overall aesthetic nature of the design.

In one embodiment, one or more designs that are the “best” of the submissions are selected in response to the evaluations (STEP 520).

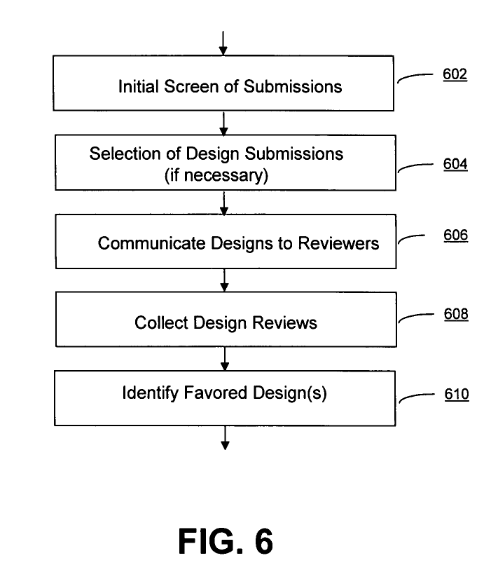

Referring to FIG. 6, in one embodiment, a screener, who may or may not be a member of the review board, performs the screening of the designs as described above (STEP 602) to eliminate as a candidate design any design that does not meet the requirements. If the design does not meet the requirements, the screener may inform the designer and allow resubmission, depending on the selection rules.

The design review board, which may be one (e.g., the one screener) or a group of people, selects a number of the submitted designs that meet the requirements, for review by a large number of reviewers (STEP 604). If there are an appropriate number of submissions, there may be no need for any further review. But, if there are a large number of submissions, the number of submissions may be reduced to a smaller number. One goal of such reduction may be to facilitate selection by a larger group, by narrowing the candidate field. Another goal of the reduction may be to select the candidates that are viewed most favorably by the members design review board. The design review board can include, for example, the screener, the facilitator, representatives of the entity that requested the design, customers of the entity that requested the design, focus groups comprised of members of the public (or the potential audience for the design), and so on. Once this selection of candidate design submissions has taken place, then reviewers can be presented with the candidates for evaluation.

For example, in one exemplary embodiment, after screening, there are 25 design submissions that meet the criteria of the requirements. The design review board decides that because of the nature of the design, it would be best to provide reviewers with 10 candidates from which to choose. The design review board selects the 10 designs that the members believe to be the best candidates. In another context, the reviewers might present all 25 to the larger group of reviewers. There may even be situations where many more candidates are presented to the larger group. In general, however, a goal is to provide the review group with a smaller number of choices, so as to reduce the time and effort needed by each member of the larger group of reviewers.

The number of designs selected can be any number that is suitable for selection by a larger group. For example, in one embodiment, designs are eliminated until 10 designs are left. In another embodiment, designs are eliminated until 20 designs are left. This additional selection of designs that meet the requirements may only be necessary if there are a large number of designs submitted. The designs may be evaluated for such exemplary factors as appearance, presentation of desired themes, color selection, and the like. The design review board can “cull” designs that the design review board members do not perceive as favorable to a set that they would find acceptable.

Depending on the number of members of the design review board, there are different techniques that can be used to select the candidates. In one embodiment, the system facilitates the review by the design review board members by presenting the choices to the members, with a mechanism to provide feedback. The feedback can be a simple indication of the preference of each (e.g., yes/no, or number evaluation) or a ranking (e.g., assigning an order of preference) to each. Any suitable technique can be used to solicit and aggregate response indicia from the design review board members. In one embodiment, each design review board member gets one or more “veto” votes to eliminate a candidate that he doesn't like.

The design review board can interact with the communication server, for example, using client software, to review the submissions and select the submissions that should be provided to the reviewing community.

In one embodiment, the design review board also considers a review of the design from the perspective of authorship and intellectual property issues. For example, the design review board can consider how similar the design submissions are to designs offered by competitors or others, to further a potential goal that the design, if selected, will not raise concerns from third-parties. The design review board may also consider the protectability of the design, with regard to copyright and trademark law. This may involve legal review, or other techniques to eliminate potential problems that may be raised by the set of candidates. Although potentially more time consuming to consider a number of candidates at this stage, rather than once a single choice is selected, it may be preferable to do so in some situations.

Once the candidate set is identified, the design review board can then consider the opinions of a larger group to determine select one or more “best” designs. The system solicits review of the selected submissions from a larger group of reviewers (STEP 606). The larger group of reviewers may be the intended audience for the design, for example, customers and potential partners of the company whose logo is being designed. The larger group of reviewers may be, in the case of a web page interface, for example, potential users of the web page. The larger group of reviewers may include other design developers, members of the requesting entity (e.g., employees of the company such as sales and marketing personnel), or any other suitable group or combination of groups of people. In one embodiment, the reviewers include people who are not affiliated with the entity, but who have agreed provide their opinion about the design. The demographics (e.g., where they live, what language(s) do they speak, their ages, incomes, etc.) of the larger group of reviewers may be important considerations in selecting the larger group.

The larger group of reviewers may be compensated in some way for their participation. For example, the reviewers may be provided with monetary or other rewards or prizes, or the opportunity to participate in a lottery for such reward. Participation in one or more larger groups of reviewers may be a requirement for submission of a design. For example, in one embodiment, a design developer needs to participate in a predetermined number of larger group reviews during a predetermined time period (e.g., week, month, calendar quarter) to have an ability to submit designs.

The larger group reviewers may be ranked and/or rated, for example based on how reliable they are, how quickly they respond, and/or how well their selections comport with the selection of the larger group(s) in the review(s) that they participate in.

In one embodiment, the larger group of reviewers is invited by email to review the designs. Each of the larger group of reviewers receives an email message directing them to a web page that includes the list of candidate designs. In the case of a logo, the candidates are displayed on the page, with any additional information needed for review, as well as a selection tool for assigning response indicia. For example, if there are ten candidate designs, each design can be assigned a response indicia from 1 to 10, and the reviewer is asked to assign a number to each design in order of the reviewer's preference for the design. In another example, the reviewers are asked to evaluate specific characteristics of the design (e.g., color, text layout, thematic representation, etc.) and/or give an overall evaluation or preference. The specific characteristics may be evaluated individually, or by assigning a number to each in order of preference. In another example, a free-form text entry field may be provided where the reviewers can describe the specific attributes (color, text, graphics, layout, etc.) of each design that they like or dislike.

While any suitable interface can be used, presenting the designs in a manner that allows each candidate design to be compared to each other facilitates efficient review by each reviewer. It also allows for effective aggregation as described below. If the designs can not easily be compared on the same page, there can be an indicator for the design on the review page, for example with a summary image for the design, and links to the full presentations of the candidate designs. Any suitable system for providing a response indicia can be used, depending on the method used for aggregating the results. Generally, a web page is used to collect the reviewers' feedback on the designs (STEP 608). Any suitable technique may be used, including without limitation selection by telephone, mobile telephone, and so on.

After review, the results from the reviewers can be aggregated, for example, by any suitable method, to identify the most preferred design(s) (STEP 610). For example, in one embodiment, the Schulze method is used for the comparison. The Schulze method has the advantage that if there is a candidate that is preferred pair-wise over the other candidates, when compared in turn with each of the others, the Schulze method guarantees that that candidate will win. Other methods that are Condorcet methods (i.e., promote the pair-wise winner) are also may be suitable, as may be any other suitable voting system, such as Borda and Instant-runoff voting.

In general, it can be useful to select a number of candidates in their order of preference, and also to communicate how close the response was from the larger group of reviewers with regard to the top selections. For example, the requesting entity may not prefer the top choice selected by the reviewers, but might prefer to select on its own from the top choices determined by the larger group. The requesting entity may conduct other reviews (e.g., marketing surveys, international review, legal review) of the most highly evaluated design, and it may turn out to raise legal concerns that would foreclose adoption.

When a design is selected, the original design developer can be engaged to do additional work with the design or another design developer can be engaged. Typically, the design developer's submission will include all of the information and documentation (including electronic copies of the design in appropriate formats) such that the design is usable in its intended context.

In one embodiment, design developers that submit designs are rated based on the results of their submissions. The ratings are calculated based on the ratings of each design developer prior to the submission, and such other factors as an assigned difficulty level of the design submitted, and the number of other design developers making submissions, and the feedback received for the design. If the difficulty is used in the rating, an assessment of the difficulty of the project will be made when it is accepted. Generally, the amount paid for a project may be related to the difficulty of the project, and so it may be possible to use one to determine the other. A skill rating is calculated for each design developer based on each developer's rating prior to the submission and a constant standard rating (e.g., 1200), and a deviation is calculated for each developer based on their volatility and the standard rating.

The expected performance of each design developer submitting a design is calculated by estimating the expected score of that design developer's submission against the submissions of the other design developers' submissions, and ranking the expected performances of each design developer. The submission can be scored by a reviewer using any number of methods, including, without limitation, those described above. The submission can be scored based on one or more metrics, or on the result of whether the submission candidate is ultimately selected. Thus, an expected score may be a score, or a reflection of the expectation that the submission will be one of the best design(s) selected.

Based on the score of the submitted software and the scores of submissions from other design developers (e.g., whether for the same design or one or more other programs having a similar level of difficulty), each design developer is ranked, and an actual performance metric is calculated based on their rank for the current submission and the rankings of the other design developers. In some cases, the submissions from other design developers used for comparison are for the same design. In some cases, the submissions from other design developers are submissions that are of similar difficulty or scope.

A competition factor also can be calculated from the number of design developers, each design developer's rating prior to the submission of the design, the average rating of the design developers prior the submissions, and the volatility of each design developer's rating prior to submission.

Each design developer can then have their performance rated, using their old rating, the competition factor, and the difference between their actual score and an expected score. This skill rating can be weighted based on the number of previous submissions received from the design developer, and can be used to calculate a design developer's new rating and volatility. In some cases, the impact of a design developer's score on one submission may be capped such that any one submission does not have an overly significant effect on a design developer's rating. In some cases, a design developer's score may be capped at a maximum, so that there is a maximum possible rating. The expected project performance of each design developer is calculated by estimating the expected performance of that design developer against other design developers and ranking the expected performances of each participant. The submissions and participants can be scored by the facilitator, the entity, a review board member, and/or automatically using the software residing, for example, on the server using any number of methods.

One example of a scoring methodology is described in U.S. Pat. No. 6,569,012, entitled “Systems and Methods for Coding Competitions” by Lydon et al, at, for example, column 15 line 39 through column 16 line 52, and column 18 line 65 through column 21 line 51. The methodology is described there with reference to programming competitions, and is applicable to rating the development of designs, as well as data models, applications, components, and other work product created as a result of using the methodology described above.

Another example is described in the example below. Again, while the example is described with respect to software coding competitions, with each participant referred to as a “coder,” it should be understood that the rating technique described is also applicable to contestants in contests involving the production of other work product.

In this example, Statistics of Rating, Volatility, and Number of Times Previously Rated are maintained for each contestant. Before competing, new contestants are assigned a provisional rating. In one embodiment, an initial rating of 1200 is designated for new contestants. In another embodiment, a provisional rating may be assigned to new contestants based on their actual performance in the competition relative to the others in the rating group.

In one embodiment, after each competition, each contestant who submitted a submission is re-rated. To perform the re-rating, a rating group is determined. The rating group may include all or a subset of the contestants who participated in a contest. This is most applicable to contests involving a large number of contestants. In contests in which there are only a small number of contestants, the group of contestants that is considered in the rating group may include contestants who submitted submissions in other competitions. In one embodiment, the last 50 submissions, whether in the current contest or in previous contests, are considered when determining the rating, excluding any of the contestant's own previous submissions.

A rating of each contestant within the rating group is determined based on an evaluation score the contestant received, as compared to the scores of the others in the rating group. The rating used for the previous scores is the rating of the coder at the time the coder submitted the solution.

The average rating of the members of the rating group is calculated according to Equation 1.

$$AveRating = \frac{{\sum }_{i = 1}^{NumCoders} {Rating}_{i}}{NumCoders} \qquad ( Equation 1 )$$

In Equation 1, NumCoders is the number of members in the rating group and Rating is the rating of the coder prior to the competition.

A competition factor (CF) is then determined according to Equation 2.

$$CF = \sqrt{\frac{{\sum }_{i = 1}^{NumCoders} {Volatility}_{i}^{2}}{NumCoders} + \frac{{\sum }_{i = 1}^{NumCoders} {( {Rating}_{i} - AveRating )}^{2}}{NumCoders - 1}} \qquad ( Equation 2 )$$

In Equation 2, Volatility is the volatility of the coder in the competition before the competition.

The probability of the coder getting a higher score than another coder in the competition (WPᵢ, for i from 1 to NumCoders) is estimated according to Equation 3. In Equation 3, Rating1 & Vol1 are the rating and volatility of the coder being compared to, and Rating2 & Vol2 are the rating and volatility of the coder whose win probability is being calculated.

$$WP = 0.5 ( erf ( \frac{Rating 1 - Rating 2}{\sqrt{2 ( Vol {1}^{2} + Vol {2}^{2} )}} ) + 1 ) \qquad ( Equation 3 )$$

Erf(z) is the “error function” encountered in integrating the normal distribution (which is a normalized form of the Gaussian function. It is an entire function, defined by Equation 4. See Eric W. Weisstein. “Erf.” From Math World—A Wolfram Web Resource. (http://mathworld.wolfram.com/Erf.html).

$$erf ( z ) ≡ \frac{2}{\sqrt{π}} {\int }_{0}^{2} {ⅇ}^{- {t}^{2}} ⅆ t . \qquad ( Equation 4 )$$

The Expected Performance EPerf of the coder is calculated according to Equation 5, where Φ is the inverse of the standard normal function.

$$EPerf = - Φ ( \frac{ERank - .5}{NumCoders} ) \qquad ( Equation 5 )$$

The actual performance (APerf) of each coder is calculated according to Equation 6. A Rank is the actual rank of the coder in the competition based on score (1 for first place, NumCoders for last). If the coder tied with another coder, the rank is the average of the positions covered by the tied coders.

$$APerf = - Φ ( \frac{ARank - .5}{NumCoders} ) \qquad ( Equation 6 )$$

The “performed as” rating (PerfAs) of the coder is calculated according to Equation 7.
PerfAs=OldRating+CF*(APerf−EPerf) (Equation 7)

The weight of the competition for the coder is calculated according to Equation 8. TimesPlayed is the number of times the coder has been rated before.

$$Weight = \frac{1}{( 1 - ( \frac{.42}{( timesPlayed + 1 )} + .18 ) )} - 1 \qquad ( Equation 8 )$$

In one embodiment, to stabilize the higher rated members, the Weight of members whose rating is between 2000 and 2500 is decreased 10% and the Weight of members whose rating is over 2500 is decreased 20%.

A cap is calculated according to Equation 9.

$$Cap = 150 + \frac{1500}{1 + TimesPlayed} \qquad ( Equation 9 )$$

The new volatility of the coder is calculated according to Equation 10.

$$NewVolatility = \sqrt{\frac{{( NewRating - OldRating )}^{2}}{Weight} + \frac{{OldVolatility}^{2}}{Weight + 1}} \qquad ( Equation 10 )$$

The new rating of the coder is calculated according to Equation 11.

$$NewRating = \frac{Rating + Weight * PerfAs}{1 + Weight} \qquad ( Equation 11 )$$

If |NewRating−Rating|>Cap, the NewRating is adjusted so it is at most Cap different than Rating.

In one embodiment, contestants have a reliability rating in addition to the skill rating. In one embodiment, the reliability rating is determined for a predetermined number (e.g., 10, 15, 20) of competitions. In one embodiment, the reliability rating is calculated as the percent of the projects that a contestant presents a timely submission that scores above a predetermined threshold. In one such embodiment, in which a contestant is required to register in advance for a competition, the reliability rating is calculated as the percent of the projects that a registers for in which that contestant presents a timely submission. In one such embodiment, the submission must be above a predetermined threshold.

In one embodiment, prizes or awards are provided, or increased, for contestants who have a reliability rating above a predetermined threshold. In one embodiment, a prize enhancement (i.e., a “bonus”), is provided to contestants who win a competition and who have a reliability rating above a predetermined threshold.

In one such embodiment, contestants are eligible to receive a bonus on top of any prize money won if the contestants' Reliability Ratings are equal to or exceed 80%. Winning members with Reliability Ratings equal to or exceeding 80% and less than 90% will receive a bonus equal to 10% of the prize. For Reliability Ratings equal to or exceeding 90% and less than 95%, winning members will receive a bonus equal to 15% of the prize. Winning members with a Reliability Rating equal to or exceeding 95% will receive a bonus equal to 20% of the prize. In one embodiment, when figuring out the reliability bonus for a contest, the reliability rating used takes into account those projects that were signed up for prior to the current project. In one embodiment, a participant with no previous projects is considered to have no reliability rating, and therefore gets no bonus.

An example of payouts based on the member's Reliability Rating is provided in TABLE 1.

TABLE 1

| 0%-79% | 80%-89% | 90%-94% | 95-100% |
|---|---|---|---|
| $5,000 | $5,500 | $5,750 | $6,000 |
| $2,000 | $2,200 | $2,300 | $2,400 |
| $500 | $550 | $575 | $600 |
| $200 | $220 | $230 | $240 |
| $100 | $110 | $115 | $120 |

The use of reliability ratings and bonus may encourage contestants to complete their submissions at a high level of quality. Because failure to meet the minimum requirements may result in a loss of the reliability bonuses, contestants are less likely to participate in contests in which they think they will be unable to submit a submission that does not meet the minimum requirements.

In one embodiment, a contestant is not allowed to register for more than a number of contests (e.g., 1, 2, 3), or within a given period of time, if the contestants' reliability rating is below a predetermined threshold (e.g., 60%, 70%, etc.) or if the contestant doesn't have a reliability rating. This restriction discourages contestants from entering into too many contests. In one embodiment, the number of contests that a contestant is allowed to enter at the same time, or within a period of time, increases as the contestants' reliability rating increases. In this way, as the contestant becomes more reliable, the contestant is allowed to enter more and more contests.

In one such embodiment, a contestant with a reliability rating below 50% is allowed to enter only one contest within a one week period, a contestant with a reliability rating above 50% but below 75% is allowed to enter only two contests within a one week period, and a contestant with a reliability rating above 75% is allowed to enter an unlimited number of contests within the one-week period.

In some embodiments, in addition to awards, ratings, and/or rankings, points are awarded to participants for participating in the competition. Points can be awarded for signing up for a competition, submitting a submission, providing a submission that passes one or more review(s), submitting a submission that scores above a certain threshold, and/or some combination or variation thereof. Points can be accumulated by participating in multiple contests, prizes awarded based on points accumulated over a period of time (e.g., monthly, quarterly, annually). In some cases, a total number of points is allocated to a competition, and the number of points awarded to each participant depends on the number of submissions for the contest (either in total or only those that pass a review test) and the score of the submissions. The total number of points attributed to a competition can vary according to elements of the contest, such as deadlines, difficulty, participation expectations (e.g., high or low), etc. By combining skill-based ratings with participation-based awards, contestants that might not to participate (because, for example, they may feel the time needed to achieve a high skill rating is too long) are motivated to participate by the periodic awarding of prizes based on participation. Furthermore, contestants that routinely submit good quality (but not necessarily winning) submissions are rewarded for their continued participation in the contests, even though they may not win individual contests.

In one embodiment, participation points are awarded to submitters who submit submissions receiving a score above a certain threshold, even if (as in some cases) the submission was not deemed to be the best submission. Participation points are awarded based on the number of submissions that are above the threshold and the placement of the scores (e.g., first place, second place, etc.)

As one non-limiting example, the allocation of points among participants in a 500-point contest can be based on the total number of submissions passing minimum review criteria and an overall design score according to TABLE 2:

TABLE 2

| | | # of Submissions that Pass Review | | | | | | |
|---|---|---|---|---|---|---|---|---|
| | Place | 1 | 2 | 3 | 4 | 5 | 6 | 7 |
| Placement | 1^{st} | 500 | 300 | 200 | 170 | 140 | 120 | 110 |
| Points | 2^{nd} | | 200 | 175 | 140 | 120 | 100 | 90 |
| | 3^{rd} | | | 125 | 100 | 90 | 85 | 80 |
| | 4^{th} | | | | 90 | 80 | 75 | 70 |
| | 5^{th} | | | | | 70 | 65 | 60 |
| | 6^{th} | | | | | | 55 | 50 |
| | 7^{th} | | | | | | | 40 |

Thus, if three submissions pass review, the first place winner receives 200 placement points, the contestant in second place receives 175 points, and the contestant in third place receives 125 points.

In some cases, points may be deducted for bugs, errors or late submissions. For example, a placement point can be deducted at some periodic interval (e.g., every four (4) hours) that a fix is late. In addition, placement points may also be deducted for bugs, errors, or other issues found in the submissions within some longer period (e.g., 30 or 60 days) of completion of the contest.

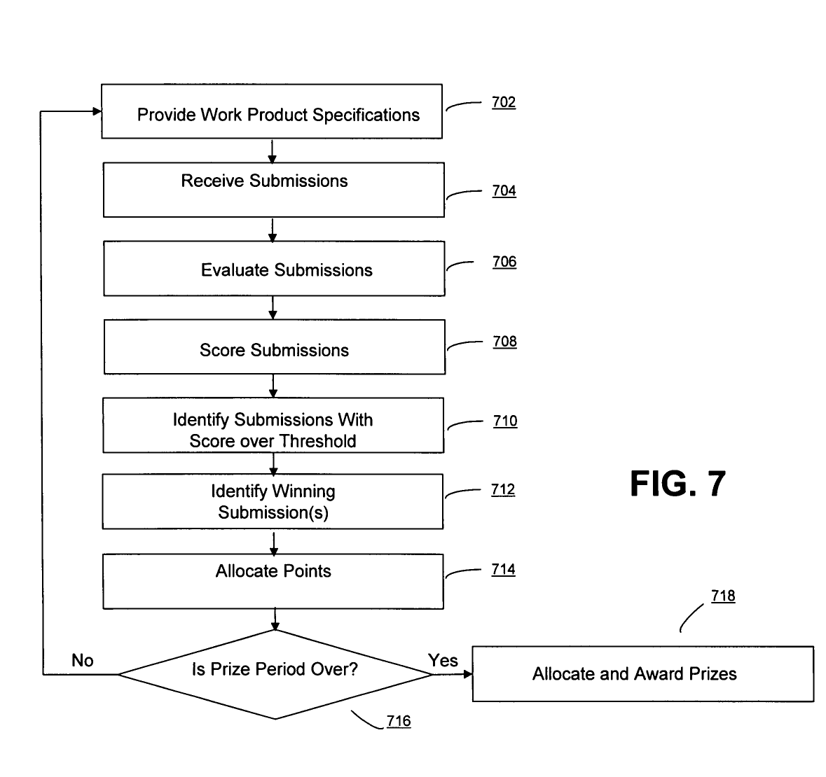

FIG. 7 provides a summary illustration of one embodiment of a method for motivating and rewarding participants in a series of production contests, for example, using the domain described above. Work product specifications (describing, for example, the scope, subject matter, aesthetic aspects, and/or functionality of the work product) are provided using the communication server (STEP 702). The specification can be communicated to the distributed community, for example, by posting to a web site that is accessed by members of the distributed community. The specification can be communicated via email, instant message (IM), or through any other suitable communication technique. The specification can also include any timing deadlines for submissions, and the points and/or prizes to be awarded for one or more selected (e.g., winning) work product(s).

One or more of the members of the community creates a submission in response to the requirements described in the specification. Once completed, the submissions(s) are communicated to, and received at the server (STEP 704). The submission(s) are then subject to an evaluation process (STEP 706). In one embodiment, one or more reviewers (e.g., skilled, experienced and/or highly rated experts, focus groups, a customer, etc.) compare the submissions to the specification, and evaluate the submissions on their implementation of the requirements (e.g., compliance with the methodology, overall aesthetic nature of the design, etc.). Based on the evaluations, the submissions are scored (STEP 708). In some cases, a minimum score (e.g., a threshold) is used to identify submissions that meet some minimum criteria (STEP 710). Of the submissions meeting the threshold score, one or more winning submissions are identified (STEP 712), and performance points are awarded (STEP 714) to one or more of the submitters. In some embodiments, the contestants also may be rated, according to a rating technique, in response to the score and a previous (or initial) rating. This rating may be a skill rating and/or a reliability rating.

In some embodiments, prizes (e.g., money, gifts, etc.) may be periodically (e.g., quarterly) awarded to the participants that accumulate the highest number of points. For example, if a prize period such as a quarter is over (STEP 716) the prizes and/or awards for that period are allocated and awarded to the contestants (STEP 718) according to the prize allocation formula for that particular period. If the prize period is not over, the contestants can continue to participate in additional production contests and earn additional points until the prizes are awarded. In some cases, the points awarded to contestants are reset at the end of each period (e.g., all contestants start the period with zero points), and in other embodiments the points are carried over from prize period to prize period.

For example, total prize pool of $75,000 may be allocated to a particular quarter, and allocated such that the participant with the highest point total (either for that quarter or on a continuous basis) receives $15,000, the second highest $10,000, the third highest $5,000, etc. until the prize pool is exhausted. In some cases, minimum point values are required to receive a prize. In some embodiments, dollar values can be attributed to participation points, such that the prize received is proportional to the number of points.

In some embodiments, portions (or all) of a prize pool can be allocated to participants that have participated in fewer than some number (e.g. 6) contests in order to encourage new participants to continue to enter contests even if they do not receive high scores. Likewise, some or all of the prize pool can be allocated to contestants that have submitted over some number (e.g., 30) submissions to reward longtime participants.

The prizes (e.g., the money, trips, merchandise, etc.) may be provided by one or more entities (208 of FIG. 2) as sponsor of a particular prize period. For example, a computer company can sponsor a year-long prize period and contribute $100,000 to the prize pool in return for advertising rights during the contests, access to the contestants (via email, for example) as well as general publicity.

In some cases, ties may exist among participants. In one embodiment, the tie-breaker is the number of higher-placed submissions submitted in the quarter. A further tie breaker can be based on the highest average individual component score of the components (or some smaller number thereof) used to develop the placement scores for the tied competitors. If a tie still remains, then the tied competitors can share prize money equally. In some cases, some portion of the prize pool is allocated to prizes for top point-earners and some portion of the prize pool is allocated for distribution among all participants.

Participants earning top prizes and/or point values may be also awarded additional prizes such as trips, access to potential employers, entries in invitation only competitions, and the like.

In embodiments where the competition includes both a design phase and a development phase (e.g., a software contest), points received from participating in the different phases may be pooled such that a participant can accumulate points during each phase. In some cases, points received from participating in different phases are segregated such that prizes can be awarded to designers having the most points and to developers having the most points independently.

In one embodiment, the external entity 208 is interested in receiving the developed design or the code, as well as obtaining developers' ratings, scores and point totals. In some cases, the entity 208 may only be interested in the ratings. For example, the external entity 208 may ask developers to participate in the development process just so that the developers are rated, and their skills can be objectively evaluated for future projects of greater value, or to determine which developers are more skilled. The requester could, in addition, have some interest in the developed design or code, and may have some interest in using the developed intellectual asset for its business or otherwise.

There can be a significant benefit to using personnel who are rated highly, using the process described above, as design reviewer(s) in the design review process and/or code reviewer(s) in the code review process. One of the traditional problems with conducting code reviews has been that the abilities of the reviewers were not established. Review by a poorly skilled developer can result in an inadequate review. By using the process to select as reviewers only developers with sufficient skill (as determined by the process), the process itself insures its success.

In one embodiment, this software development process is adopted by a software development group within an organization. The development performed by the group is conducted using this process. Each developer in the group has a rating, and the developers work to improve and/or maintain their ratings. Developers who have high ratings can participate in reviews (e.g., the design review process or the code review process). In one implementation, developers receive additional benefits and or compensation for achieving a high rating. Likewise, developers can receive additional benefits and/or compensation for such participation in a review process. The requestors in this example are product or program managers, charged with directing the software development.

In another implementation, an outside organization such as a consultant can use the system and methods described above to evaluate and rate the development competencies of a development group. In this way, the consultant can rate the developers not only against themselves, but against other developers affiliated with other organizations who have participated or are participating in the system. The evaluator provides the service of evaluation and reporting as described above. One benefit to this approach is that the scoring of the intellectual assets are more likely to be unbiased if the reviewers are not personally known to the developers, and comparing the skills of any one developer against a large pool of developers provides a more accurate representation of that developers skill level with respect to his or her peers.

In general, the process of soliciting work product from a large, disperse, and often unrelated group of individuals for potential inclusion into a resulting product (whether it be tangible or intangible) can be applied in any situation in which such submissions can be received and evaluated. By breaking the desired end product (e.g., software application, automobiles, textbooks, songs, etc.) into components of increasingly smaller granularity and advertising the need for such components to a large pool of candidates (some of which may have been pre-screened), the ability to find and evaluate the work product that meets the specific requirements for that component increase.

Thus, the method may be applied to the production of any type of intellectual assets that are the result of intellectual work. Just as examples, these intellectual assets can include any sort of design, drawing, invention, creation, development, work of authorship, diagnosis, treatment, proposal, suggestion, and so on. Just as examples, these intellectual assets might be generated by engineers, designers, developers, architects, doctors, nurses, lawyers, veterinarians, planners, and so on, whether as individuals, groups, firms, collectives, and so on.

Preferably, the production of the intellectual asset is accomplished such that the production of the asset or portions of the asset can be accomplished by a contestant in a reasonable period of time, and the evaluation criteria sufficiently clear that the contestant can determine whether the contest is worth participating in. This may be accomplished by providing clear guidelines and rules for evaluation, as appropriate for the work product in question. For example, if the work product is an engineering design, review by design engineers would be appropriate. If the work product is a song, review by a small number of knowledgeable song writers or producers may be appropriate and/or review by a large number of potential customers may be appropriate.

In all cases, appropriate portioning (e.g., division and/or subdivision) of the production task into one or more work product elements may be necessary such that each production task may be accomplished by contestant(s) with a particular skill set. It also may be useful to construct the discrete tasks such that they may be accomplished by an individual or team without interaction with any other contestant so that tasks may be accomplished in parallel. The activity of portioning of an intellectual asset may itself be work product that may be accomplished by way of a production contest. Likewise, the aggregation of sub-divided work-product elements into a desired asset may be accomplished by way of a production contest.

As an example, a car manufacturer that traditionally buys brakes for all of its models from one brake manufacturer, the manufacturer can publish a set of specifications (for each type of car, potentially) and any brake manufacturer can then bid on supplying the brakes in much smaller volumes. The brake suppliers can then apply this model to its suppliers (disk manufacturers, cylinder parts makers, etc.). Using these techniques, the brake manufacturer has access to hundreds or even thousands of people, groups of people and companies that have specified knowledge and/or skill in a distinct area—e.g., building braking systems. Instead of the traditional challenges of how to manage a large internal workforce, the company can use the processes described herein to manage customized product design at a large scale. For example, the company will be able to determine, design, and manufacture the optimal components to be included in a large list of customized brake systems and supply these systems to automobile manufactures. As a result, the variability of products increases (allowing the company to provide specialized braking systems for numerous applications) while decreasing the cost.

The process can be applied to the production of virtually any activity where the output can be evaluated based on some pre-agreed criteria, where the company can assess the risk of agreeing to provide some work product based on the opportunity cost of making that product and the potential reward for each product. As another example, a song (or even an album or soundtrack) includes various components (e.g., lyrics, music, instrument tracks, vocal tracks, and arrangements) that can be combined into an end product. Using the techniques described herein, a recording artist or studio can access a pool of musicians and composers, and evaluate each person's submission such as a piano track for one particular song. The criteria may be based on an individual's personal likes, or in some cases the track (or tracks for different versions of the song) can be selected based on input from a set of reviewers. Using this approach, songs could be written and recorded using many different songwriters and musicians. The contestants would maintain interest in the process by receiving points for consistently delivering work product that gets evaluated above some relative threshold.

The same model can be applied to service offerings such as law, accounting, landscaping, medical services, etc. For example, a company needing various legal services such as incorporation papers, employee agreements, license agreements, reviews of lease agreements, patent applications, trademark filings, etc. can use the methods and systems of the invention to solicit multiple submissions from various firms. By allocating points to each participating firm (or individual attorney), the participants can receive compensation for their efforts, even if their submission was not selected for use. In some embodiments, the firms may use similar techniques to produce the end product, such as a draftsman, a patent attorney, and a software engineer to provide the drawings, claims, and specification of a patent application, respectively.

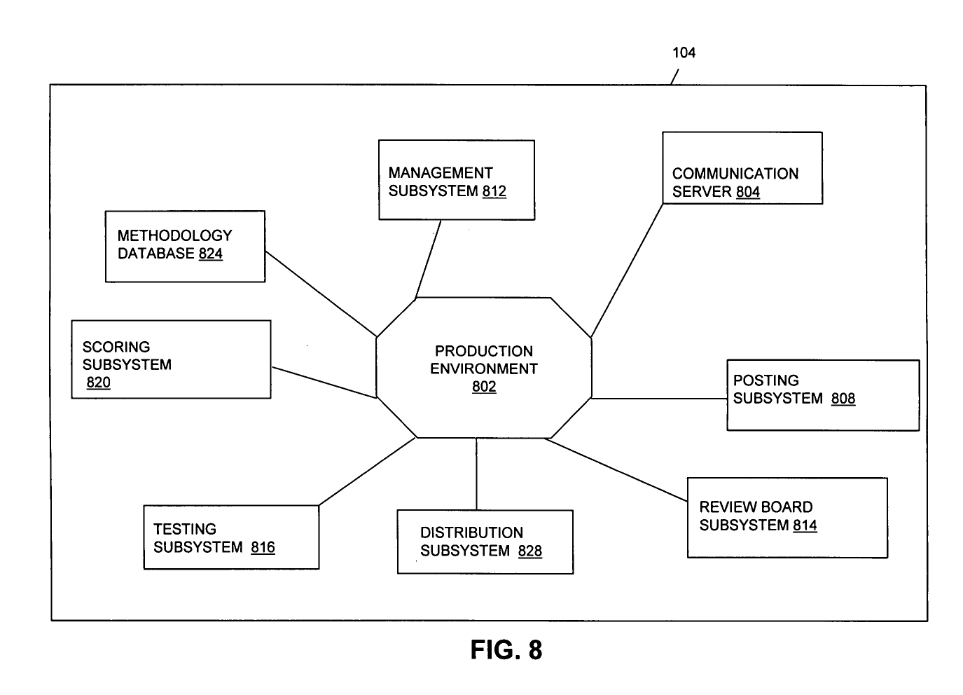

Referring to FIG. 8, the server 104 can include a number of modules and subsystems to facilitate the communication and development of software specifications, designs and programs. The server 104 includes a communication server 804. One example of a communication server 804 is a web server that facilitates HTTP/HTTPS and other similar network communications over the network 112, as described above. The communication server 804 includes tools that facilitate communication among the distributed community of programmers 212, the external entity 208, the facilitator 400, and the members of the review board(s) (commonly referred to as “users”). Examples of the communication tools include, but are not limited to, a module enabling the real-time communication among the developers 404 (e.g., chat), news groups, on-line meetings, and document collaboration tools. The facilitator 400 and/or the external entity 208 can also use the communication server 804 to post design or specifications for distribution to the distributed community of programmers 212.

Furthermore, the server 104 also includes a development environment 802 to facilitate the software development domain 204 and the design and development process, for example, and the subsystems and modules that support the domain 204. For example, the server 104 can include a development posting subsystem 808, a management subsystem 812, a review board subsystem 814, a testing subsystem 816, a scoring subsystem 820, a methodology database 824, and a distribution subsystem 828.

In one embodiment, the development posting subsystem 808 allows users of the system to post specifications, submit designs, post selected designs, submit software programs and test cases, and post selected software programs for distribution. The posting subsystem 808 identifies the users based on their role or roles, and determines which functions can be accessed based on individual security and access rights, the development phase that a project is currently in, etc. For example, if a particular project is in the design development phase, the posting subsystem 808 can determine that the external entity sponsoring the project has read/write access to the specification, and can re-post an updated specification if necessary. The facilitator 400 may have read access to the specification, as well as access to other specifications attributed to other external entities they may support. In some embodiments, the entire distributed community of programmers may be able to view all of the currently pending specifications, however the posting subsystem may limit full read access to only those developers meeting one or more skill or rating criteria, as described above. Once designs are submitted, access to the submitted designs can be further limited to only review board members, or in some cases other participants in the process.

The development posting subsystem 808 also enables the server 104 or other participants to communicate with potential developers to promote development projects and grow the community of programmers that participate in the development process. In one embodiment, the development posting subsystem 808 displays an advertisement to potential developers. In one embodiment, the advertisement describes the project using text, graphics, video, and/or sounds. Examples of communication techniques include, without limitation, posting these ads on the server's web site, displaying statistics about the project (e.g., planned royalties paid to developers, developers who are participating in this project, development hours available per week). Moreover, in one embodiment the development posting subsystem 808 accepts inquiries associated with development projects. In further embodiments, the development posting subsystem 808 suggests development opportunities to particular developers. The development posting subsystem 808 may analyze, for example, the rating of each member of the distributed community, previous contributions to previous development projects, the quality of contributions to previous component development projects (e.g., based on a score given to each developer's submission(s) as discussed above), and current availability of the developer to participate.

The server 104 also includes a management subsystem 812. The management subsystem 812 is a module that tracks the progress of design and development projects using the software development environment 204. The management subsystem 812 also facilitates the enrollment of new users of the system, and assigns the appropriate security and access rights to the users depending on the roles they have on the various projects. In some versions, the management subsystem 812 can also compile and track operational statistics of the software development environment 204 and users of the system. For example, to determine the appropriate compensation to be awarded to a developer submitting a wining design, the management subsystem 812 may review previously completed projects and assign a similar cash award. Similarly, in cases where the difficulty level of a posted design or program is very high, the management subsystem 812 can review information about individual programmers to determine those developers who have historically performed well on like projects. In addition, the management subsystem 812 may be used to analyze overall throughput times necessary to develop operational programs from a specification provided by an external entity. This can assist users of the system in setting the appropriate deliverable dates and costs associated with new projects.

The server 104 also includes a review board subsystem 814. The review board subsystem 814 allows review board members, external entities, the facilitator, and in some cases developers in the distributed community to review submissions from other developers, as described above. In one embodiment, the communication server 804, the development posting subsystem 808, the management subsystem 812, the review board subsystem 814, the testing subsystem, the scoring subsystem, and the methodology database reside on the server 104. Alternatively, these components of the software development environment 204 can reside on other servers or remote devices.

The server 104 additionally includes a testing subsystem 816. The testing subsystem 816 enables the testing of the submitted programs, applications and/or components. In one embodiment, the testing server 808 is used by the review boards, the facilitator 400, and/or the external entity 208 to review, evaluate, screen and test submitted designs and software programs. The testing subsystem 816 can also execute test cases developed and submitted by the developer 404 against some or all of the submitted programs, as described above. Moreover, the testing subsystem 816 may execute an automated test on the component or application, such as to verify and/or measure memory usage, thread usage, machine statistics such as I/O usage and processor load. Additionally, the testing subsystem 816 can score the component by performance, design, and/or functionality. The testing subsystem 816 can be a test harness for testing multiple programs simultaneously.

The server 104 also includes a scoring subsystem 820. In one embodiment, the scoring subsystem 820 calculates scores for the submissions based on the results from the testing subsystem 816, and in some embodiments ratings for each participant in one or more coding competitions, previous development submissions, or both. In other embodiments, the scoring subsystem 820 can calculate ratings for developers based on their contributions to the project. In embodiments where points are awarded for participation in the contests, the scoring subsystem 820 calculates the points awarded to each contestant. In one embodiment, the scoring subsystem 820 allocates prizes as described above.

The server 104 also includes a methodology database 824. The methodology database 824 stores data relating to the structured development methodology 220. In one embodiment, the methodology 220 may stipulate specific inputs and outputs that are necessary to transition from one phase of the development project to the next. For example, the methodology 200 may dictate that, in order to complete the specification phase of the project and being the design phase, a checklist of items must be completed. Furthermore, the methodology database 824 may store sample documents, designs, and code examples that can be used as templates for future projects, and thus impose a standardized, repeatable and predictable process framework on new projects. This standardization reduces the risks associated with embarking on new software development projects, shortens the overall duration of new development projects, and increases the quality and reliability of the end products.

The server 104, also includes distribution subsystem 828. The distribution subsystem 828 can track and store data relating to software products (e.g., specifications, designs, developed programs) that have been produced using the domain 204. In one embodiment, the distribution subsystem 828 includes descriptive information about the entity 208 that requested the product, the entry and exit points of the domain 204, significant dates such as the request date, and the delivery date, the names and/or nicknames of the developers that participated in the development of the product. The distribution subsystem 828 can also include detailed functional information about the product such as technology used to develop the product, supported computing environments, as well as others. In some embodiments, previously distributed software products may be updated or patched, as described above. In such cases, the distribution subsystem 828 facilitates the identification of the entity or entities 208 that may have older versions of the product, and subsequent communication and distribution of updated versions, where applicable. In some cases, the distribution subsystem 828 can also function as a source code management system, thereby allowing various versions of previously developed software products to branch into distinct software products having a common provenance.

Although described above as independent subsystems and modules, this is for exemplary purposes only and these subsystems and modules may alternatively be combined into one or more modules or subsystems. Moreover, one or more of the subsystems described above may be remotely located from other modules (e.g., executing on another server 104 in a server farm).

Although described here with reference to software, and useful when implemented with regard to software components, the cooperatively developed product can be any sort of tangible or intangible object that embodies intellectual property. As non-limiting examples, the techniques could be used for computer hardware and electronics designs, or other designs such as architecture, construction, or landscape design. Other non-limiting examples for which the techniques could be used include the development of all kinds of written documents and content such as documentation and articles for papers or periodicals (whether on-line or on paper), research papers, scripts, multimedia content, legal documents, and more.

What is claimed is:

1. A method for motivating participants in a plurality of production competitions, the method comprising:
conducting a plurality of production competitions which contestants each submit a submission;
for each competition:
(i) evaluating contestants' submissions;
(ii) assigning a score to contestants' submissions in response to the evaluation;
(iii) identifying a number of submissions having a score above a threshold value;
(iv) designating the contestant who submitted a submission having a score above the threshold value that is a highest score to be a winner of that competition; and
(v) awarding performance points to contestants who submitted the identified submissions; and
periodically awarding prizes to a plurality of contestants receiving the greatest number of performance points during the period.

2. The method of claim 1 wherein the production competitions are software programming competitions.

3. The method of claim 1 wherein the production competitions are software design competitions.

4. The method of claim 1 wherein the production competitions are graphic design competitions.

5. The method of claim 1 wherein the production competitions are user interface design competitions.

6. The method of claim 1 wherein the production competitions are software assembly competitions.

7. The method of claim 1 wherein the production competitions are writing competitions.

8. The method of claim 1 wherein the submission is a design.

9. The method of claim 1 wherein the submission is software code.

10. The method of claim 1 wherein the submission is an assembled software application.

11. The method of claim 1 wherein the evaluation is conducted by a number of evaluators.

12. The method of claim 11 wherein the evaluating step is conducted such that during evaluation an evaluator does not know the identity of the contestant who submitted the submission.

13. The method of claim 1, further comprises, after step (i), determining whether contestants' submissions meet minimum submission requirements.

14. The method of claim 1, further comprising after step (iv), awarding a prize to the designated winner of the competition.

15. The method of claim 1, wherein step (iv) further includes, if there are two submissions having a score above the threshold, designating the two contestants who submitted the two respective submissions having a score above the threshold that are the highest scores to be the respective winner and second-place finisher of that competition.

16. The method of claim 15, further comprising, after step (iv), awarding a prize to the winner of the competition and the second place finisher of the competition.

17. The method of claim 1, wherein the score is determined by evaluating the submissions against one or more criteria.

18. The method of claim 1, wherein the performance points are awarded in response to the number of submissions having a score above the threshold.

19. The method of claim 1, wherein the step of periodically awarding prizes is performed quarterly.

20. The method of claim 1, wherein the step of periodically awarding prizes is performed yearly.

21. The method of claim 1, wherein the step of periodically awarding prizes is performed quarterly and yearly.

22. The method of claim 1, further comprising, the step of determining a rating for each contestant in response to the score and a previous rating.

23. The method of claim 22, wherein the previous rating is an initial rating.

24. A method for generating an intellectual asset, comprising the steps of:
portioning production of the asset into production of one or more work product elements that can be produced by a submitter;
for work product elements that can be produced by a submitter, conducting a production competition for the production of work product in which contestants each submit a work product submission, further comprising:
describing the requested work product;
receiving contestants work product submissions;
evaluating contestants' work product submissions;
assigning a score to contestants' work product submissions in response to the evaluation;
identifying a number of work product submissions having a score over a threshold value;
designating the contestant who submitted a submission having a score above the threshold value that is a highest score to be a winner of the competition; and
awarding performance points to contestants who submitted the identified work product submissions; and
periodically awarding prizes to a plurality of contestants receiving the greatest number of performance points during the period.

25. The method of claim 24 wherein the description of the requested work product comprises criteria on which the work product will be evaluated.

26. A computerized system for motivating participants in production competitions, the system comprising:
a communications server for communicating requirements for a submission to contestants and, in response to the communicated requirements, receiving from each of a subset of the contestants a candidate submission;
a testing server for evaluating each of the received submissions; and
a scoring server in communication with the testing server for:
(i) scoring, the submissions based at least in part on evaluation results received from the testing server;
(ii) identifying submissions with scores above a threshold; and
(iii) allocating performance points to those contestants that submitted the identified submissions.

27. The system of claim 26 wherein the scoring server further allocates performance points based on the number of submissions with scores above the threshold.

28. The system of claim 26 further comprising a data storage module for storing evaluation criteria on which the evaluations are based.
